(19) United States
(12) Patent Application Publication
(10) Pub. No.: US 2006/0283657 A1
(43) Pub. Date: Dec. 21, 2006

(54) Perforated foamed panel for air handling units

(75) Inventors: Harold J. Dubensky, Columbia, PA (US); Harvey David Elder, York, PA (US); Patrick Christian Marks, York, PA (US); David Michael, Manchester, PA (US); Wayne Pierjok, Gallatin, MO (US); Dennis R. Runkle, York, PA (US); Martin Dale Weatherd, Stanberry, MO (US)

Correspondence Address: MCNEES, WALLACE & NURICK LLC, 100 PINE STREET, P.O. BOX 1166, HARRISBURG, PA, 17108-1166, US

(73) Assignee: YORK INTERNATIONAL CORPORATION, York, PA (US)

(21) Appl. No.: 11/153,688

(22) Filed: Jun. 15, 2005

(51) Int. Cl. G10K 11/04

(52) U.S. Cl. 181/200

(57) ABSTRACT

A panel provided for use in an air handling unit includes a skin and a fixture, the fixture and the skin composed of a metal material. The fixture has a base, with an opening formed in the base. The base includes at least one riser extending substantially perpendicular to the base, the at least one riser being secured to the skin to form an enclosed chamber between the skin and the fixture. A perforated sheet is disposed over the opening, a layer of film disposed on a surface of the perforated sheet facing the skin. A first insulating material is disposed on a surface of the film layer opposite the perforated sheet. A second insulating material is disposed in the enclosed chamber between the first insulating material and the skin.

### FIELD OF THE INVENTION

The present invention is directed to thermally-enhanced HVAC constructions or components, and more particularly, is directed to thermally-enhanced foam-containing HVAC constructions or components.

### BACKGROUND OF THE INVENTION

Heating, ventilation and air conditioning (“HVAC”) systems are commonly used in many climate control applications. Air Handling Units (AHUs) are one of several components in HVAC systems. They are an important component as the AHU houses a number of components used in the system to provide forced air for climate control in a particular structure. AHU components typically include motors, heating/cooling coils, and blowers as well as the required interface connections to these components to effect such climate control.

The AHU is an enclosed interconnected framed panel structure. The framed panel structures have insulated panels that are supported between framing members, also referred to as raceways, to define interconnected rectangular compartments. Typically, the insulating material used in the panel is polyurethane foam that may be installed as a block, or injected as a foam, which cures to form a core within the panel. Although polyurethane foam insulation has superior insulating and indoor air quality (“IAQ”) properties versus fiberglass insulation, polyurethane foam does not attenuate noise generated within the AHU as well as fiberglass insulation. Conversely, items such as household appliances, walk-in coolers and air conditioning units utilize fiberglass insulation, but not polyurethane foam, so while operating with enhanced noise reduction, these items may lack enhanced thermal insulation.

What is needed is a thermally-enhanced HVAC construction that can be used with HVAC units that provides enhanced thermal insulation and noise reduction, as well as structural strength and stiffness.

### SUMMARY OF THE INVENTION

The present invention relates to a panel for use in an air handling unit including a skin and a fixture. The fixture has a base disposed opposite the skin, an opening formed in the base, and at least one riser extending substantially perpendicular from the base. The at least one riser is secured to the skin to form an enclosed chamber between the skin and the fixture. A perforated sheet is disposed over the opening and a layer of film is disposed on a surface of the perforated sheet facing the skin. A first insulating material is disposed on a surface of the film layer opposite the perforated sheet and a second insulating material is disposed in the enclosed chamber between the first insulating material and the skin.

The present invention further relates to an air handling unit framework including a skin and a fixture. The fixture has a base disposed opposite the skin and an opening formed in the base. At least one riser extends substantially perpendicular to the base, the at least one riser being secured to the skin to form an enclosed chamber between the skin and the fixture. A perforated sheet is disposed over the opening; a layer of film disposed on a surface of the perforated sheet facing the skin. A first insulating material is disposed on a surface of the film layer opposite the perforated sheet. A second insulating material is disposed in the enclosed chamber between the first insulating material and the skin. A plurality of interconnected structural members forming a plurality of interconnected frames, each frame of the plurality of frames receiving a panel. The plurality of interconnected frames and corresponding panels are configured and disposed to form an air handling unit framework.

The present invention also relates to a method of assembling a panel for use in an air handling unit. The method includes providing a skin and providing a fixture. The fixture includes a base disposed opposite the skin having an opening formed in the base and at least one riser extending from the base. The method also includes bending the at least one riser substantially perpendicular from the base, disposing a perforated sheet over the opening, and disposing a layer of film on a surface of the perforated sheet facing the skin. The method further includes disposing a first insulating material on a surface of the film layer opposite the perforated sheet, securing the at least one riser to the skin to form an enclosed chamber between the skin and the fixture, and disposing a second insulating material in the enclosed chamber between the first insulating material and the skin.

An advantage of the present invention is improved thermal insulation performance characteristics for HVAC systems.

A yet further advantage of the present invention is insulated panels having improved acoustic attenuation characteristics in household appliances, walk-in coolers and air conditioning units.

A still further advantage of the present invention is that it has enhanced strength and stiffness properties.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is an overall perspective view of an AHU of the present invention;

FIG. 2 is a perspective view of a raceway of the present invention;

FIG. 3 is a cross section of the raceway of the present invention;

FIG. 4 is an exploded perspective view of insulated panels prior to insertion into adjacent raceway frames of the present invention;

FIG. 5 is a flat pattern of a fixture of the insulated panel of the present invention;

FIG. 6 is a perspective view of the partially fabricated fixture of the insulated panel of FIG. 5 of the present invention;

FIG. 7 is a cross section of the insulated panel taken along line 7-7 of FIG. 4 of the present invention; and

FIG. 8 is an exploded perspective view of adjacent raceway frames of the present invention.

Other features and advantages of the present invention will be apparent from the following more detailed description of the preferred embodiment, taken in conjunction with the accompanying drawings which illustrate, by way of example, the principles of the invention.

### DETAILED DESCRIPTION OF THE INVENTION

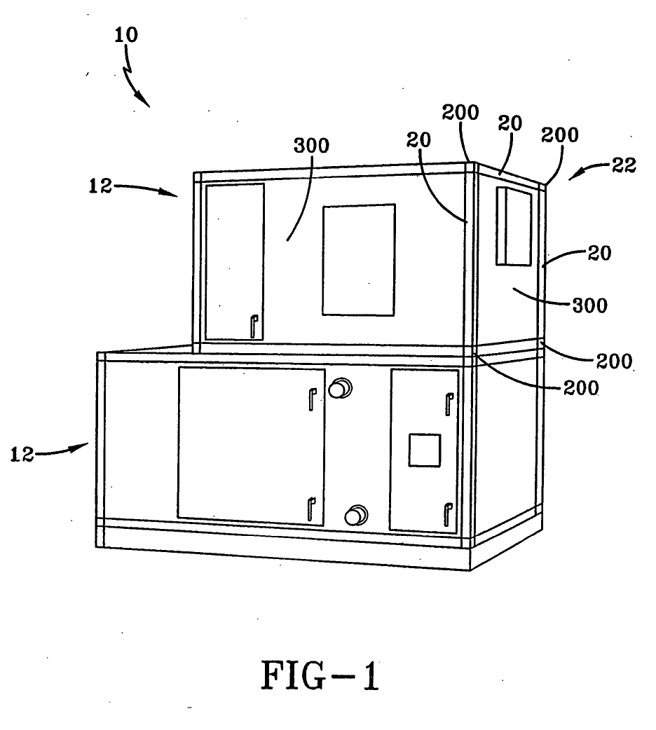

One embodiment of an AHU 10 that incorporates a thermally enhanced component or construction of the present invention is depicted in FIG. 1. AHU 10 is an enclosed framed panel structure 12, or has a series of interconnected framed panel structures 12. Each framed panel structure 12 preferably defines a rectangular compartment that is configured to enclose or house components, which provide forced air for climate control in a particular structure. AHU components typically include motors, heating/cooling coils, and blowers as well as the required interface connections to these components to effect such climate control. Framed panel structures 12 have a plurality of insulated panels 300 that are each structurally and sealingly supported by a raceway frame 22. Each raceway frame 22 is comprised of a plurality, of raceways 20, preferably four, that are interconnected by corner members 200.

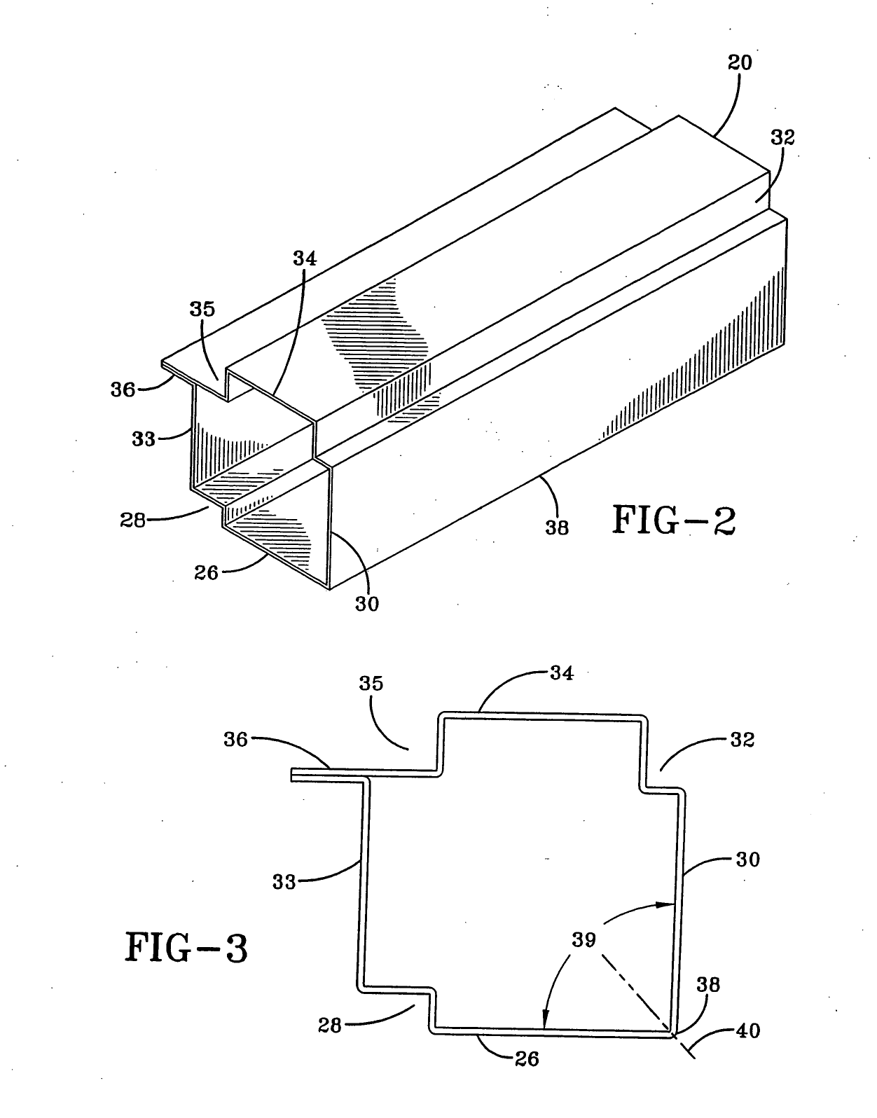

Referring to FIGS. 2, 3 and 8, in a preferred embodiment of the present invention, raceway 20 defines a closed geometric profile including a first surface 26 which extends to a substantially squared first recess 28, a second surface 30 extending into a substantially squared second recess 32, a first closing portion 33 extending from first recess 28, a second closing portion 34 extending from second recess 32, a substantially squared third recess 35 extending from second closing portion 34, and first closing portion 33 and third recess 35 terminating at a common flange 36. First and second surfaces 26, 30 have a common edge 38 and are substantially perpendicular to each other. The collective profile defined by first surface 26 and first recess 28 is a mirror image of the collective profile defined by second surface 30 and second recess 32 about a plane 40 (plane of symmetry) passing through common edge 38 that bisects angle 39 between first and second surfaces 26, 30. Preferably, first and second surfaces 26, 30 are orthogonal, thus, angle 39 is ninety degrees and plane 40 is forty five degrees from each of first and second surfaces 26, 30.

To form a preferably rectangular raceway frame 22 using the raceways 20, four mutually perpendicular, coplanar raceways 20 are interconnected end-to-end by corner members 200 (FIG. 1). By then interconnecting two opposed raceway frames 22 end-to-end using four raceways 20, wherein the end of each raceway 20 is connected to a corresponding corner of each of the two raceway frames 22, a rectangular framework is formed which defines a preferably rectangular structural framework for AHU 10. FIG. 8 shows two adjacent raceway frames 22 having a common raceway 21 that is common to each of the two raceway frames 22. Each of the raceway frames 22 includes a phantom outline 70, 72, defining a peripheral recess that is provided to receive a respective insulated panel 300 therein. Thus, a typical rectangular structural framework, which defines six open raceway frames 22, becomes an enclosed, interconnected framed panel structure upon receiving a respective insulated panel 300 in each of the peripheral recesses of the six raceway frames 22. By virtue of the symmetry of raceway 20, a single raceway profile may be used for each raceway 20 that is used to construct the structural framework for AHU 10 to provide identical, continuous peripheral seams or recesses for structurally securing each side of each insulated panel. While the above design for the raceway 20 is preferred, it is to be understood that any suitable design for raceway 20 can be used.

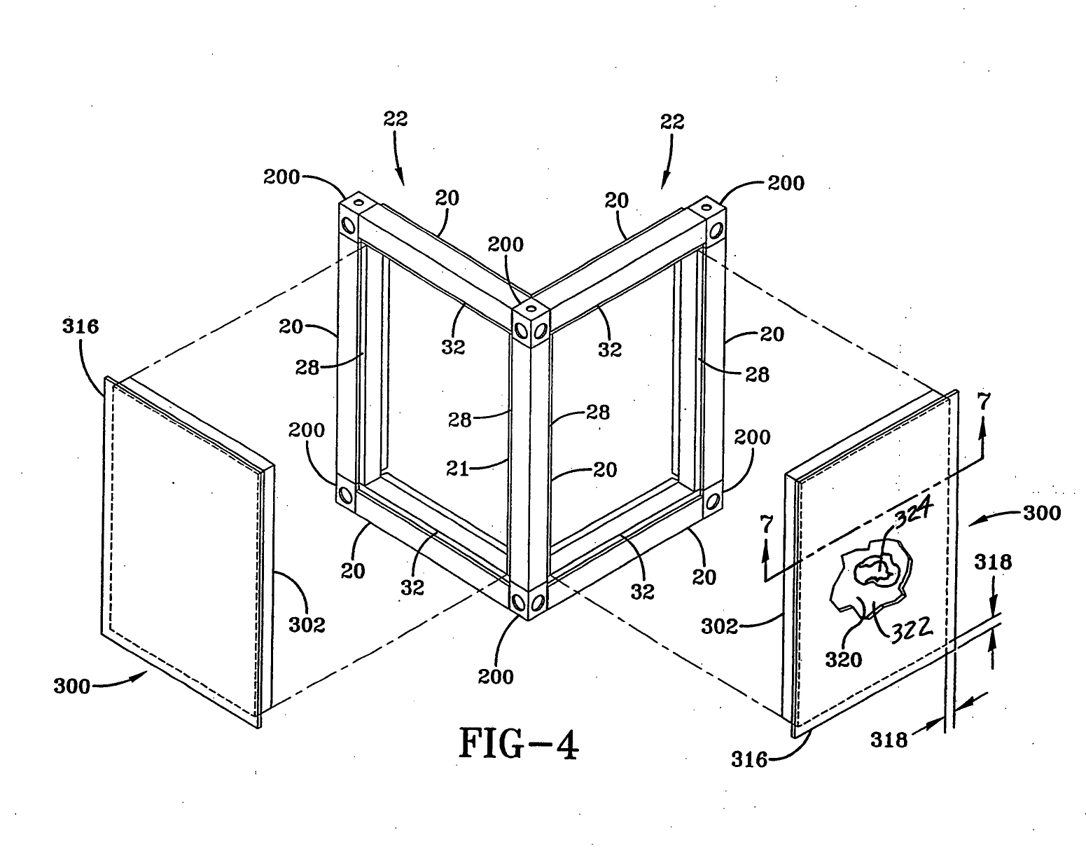

Referring to FIG. 4, two adjacent raceway frames 22 each receiving the corresponding insulated panel 300 are shown, which raceway frame 22 has raceways 20 that are interconnected by corner members 200. Common to each raceway frame 22 is the raceway 20 that is located at the common corner, which raceway being referred to as a common raceway 21. One raceway frame 22 peripherally receives each of the four sides of the exterior skin 316 of its corresponding insulated panel 300 in second recess 32 formed in each raceway 20. While the other raceway frame 22 also peripherally receives the four sides of the exterior skin 316 of its corresponding insulated panel 300, two of the four sides of the exterior skin 316 are received in first recess 28 that is formed in two of the raceways 20, and the remaining two sides of the exterior skin 316 are received in second recess 32. Common raceway 21 (and each of the other vertically oriented raceways 20) can simultaneously secure one side of each of two different insulated panels 300, one side of each insulated panel 300 being supported in one first recess 28.

To increase the efficiency of the heating and cooling system, raceways 20 are injected with insulating material (not shown). Since the insulating material is preferably applied to substantially completely fill the interior of the raceways 20, the formation of condensation is likewise significantly eliminated which is a major cause of corrosion for the raceways 20, which are typically composed of metal, such as stainless steel or a galvanized coating applied to a steel alloy.

Referring to FIGS. 4-7, insulated panel 300 is provided for insertion in the first and/or second recesses 28, 32 formed along the raceways 20 that are interconnected by connectors 200 to form framed structures 22 used with AHUs. Insulated panel 300 of the present invention is constructed using a minimum of parts and may be sized according to a customer's individual needs to define any number of different aspect ratios and dimensions, preferably down to at least one inch increments, while still complying with structural stiffness standards and assembled air leakage standards. Additionally, a single panel construction may be employed irrespective the location of the panel in the AHU. That is, ceiling, wall and floor panel constructions are the same.

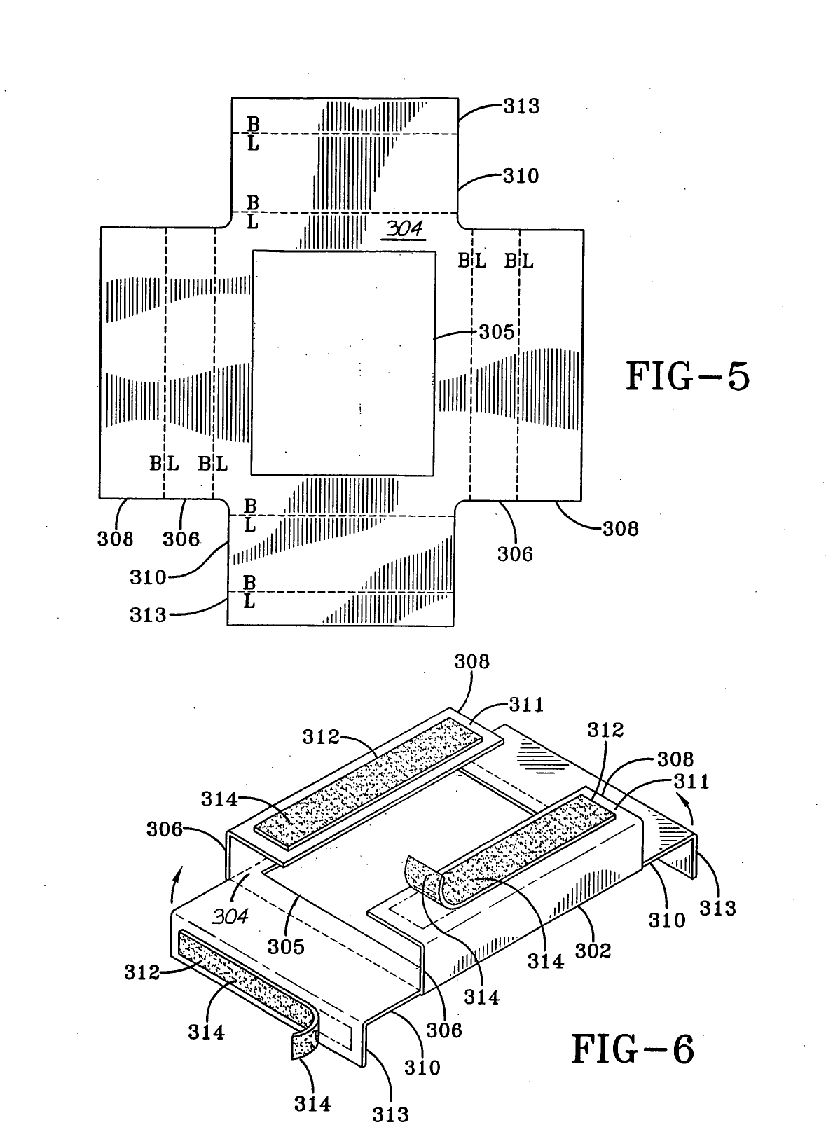

Fixture 302 is preferably constructed of sheet metal, such as stainless steel, although other materials for use in HVAC systems that are sufficiently formable or moldable with sufficient strength and heat resistant properties may also be used. Fixture 302 comprises a centrally positioned base 304 having opposed risers 306 extending from sides of base 304 in a direction substantially perpendicular to base 304, which risers 306 further extend to outwardly (or inwardly) directed coplanar flanges 308, and opposed ends 310. Preferably, an opening 305 is formed in base 304, removing a significant portion of material from the base 304. However, sufficient material remains between bend lines 307 that define the outer perimeter of the base 304 and the opening 305 so that the assembled fixture 302 maintains its structural integrity. When opposed risers 306, flanges 308, end risers 310 and end flanges 313 are rotated into a desired position, which opposed risers 306 and end risers 313 being substantially perpendicular to base 304, the assembled fixture 302 resembles a rectangular block with an opening into the block due to the space between opposed flanges 308 and end flanges 313. That is, if the opposed flanges 308, and/or the opposed end flanges 313 extend inwardly, the opening in the assembled fixture 302 is defined by the space between the opposed flanges 308 and/or the opposed flanges 313. However, if the opposed flanges 308 and/or the end flanges 313 extend outwardly, the opening in the assembled fixture 302 is defined by the space between the opposed risers 306 and opposed end risers 310. As shown in FIG. 6, the opposed flanges 308 extend inwardly, while opposed end flanges 313 extend outwardly. Preferably, a layer of foam tape 312, such as polyethylene tape, having opposed adhesive layers 314 is applied along outside surfaces 311, 313 of each respective flange 308 and end flange 313 for bonding fixture 302 to the exterior skin 316. This foam tape 312 also has a low thermal conductivity, and serves as a thermal barrier to conduction. Alternately, other bonding methods or materials may be employed having similar physical properties.

Exterior skin 316 is positioned over fixture 302, the length of overhang 318 between the ends of the exterior skin 316 and the corresponding sides and ends of the fixture 302 preferably being substantially the same. However, prior to assembling exterior skin 316 to fixture 302, a perforated sheet 326, preferably composed of sheet metal or other compatible material, is installed inside the fixture 302. The perforated sheet 326 abuts the remaining peripheral portion of the base 304 and overlies opening 305 of the base 304 of fixture 302. Once the perforated sheet 326 is installed, a sheet of film, 328 such as mylar, is installed to a surface of the perforated sheet 326 that is opposite the opening 305. Once the film sheet 328 has been installed, a block of a first insulating material 322, such as fiberglass insulation, is then installed over the film 328, the perforated sheet 326 and the base 304. Exterior skin 316 can then be assembled to the fixture 302 as previously discussed.

It is appreciated that in an alternate embodiment, perforated sheet 326 can be installed outside the fixture 302 over the fixture opening 305 of the base 304, with the film 326 sandwiched between the perforated sheet 326 and the base 304. Mechanical fasteners, adhesive or other devices or techniques known in the art can be used to secure the perforated sheet 326 to the base 304.

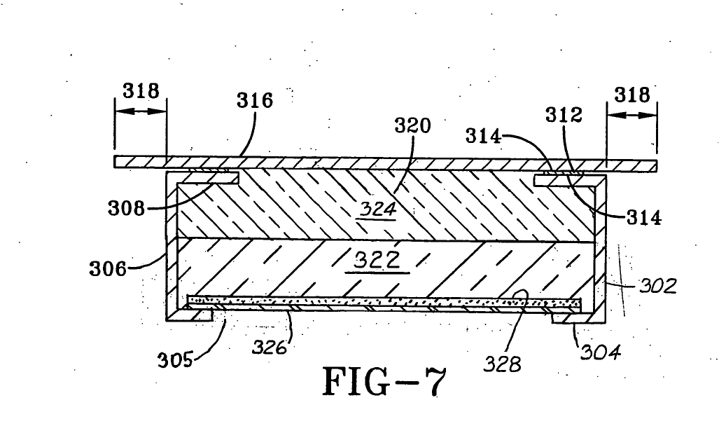

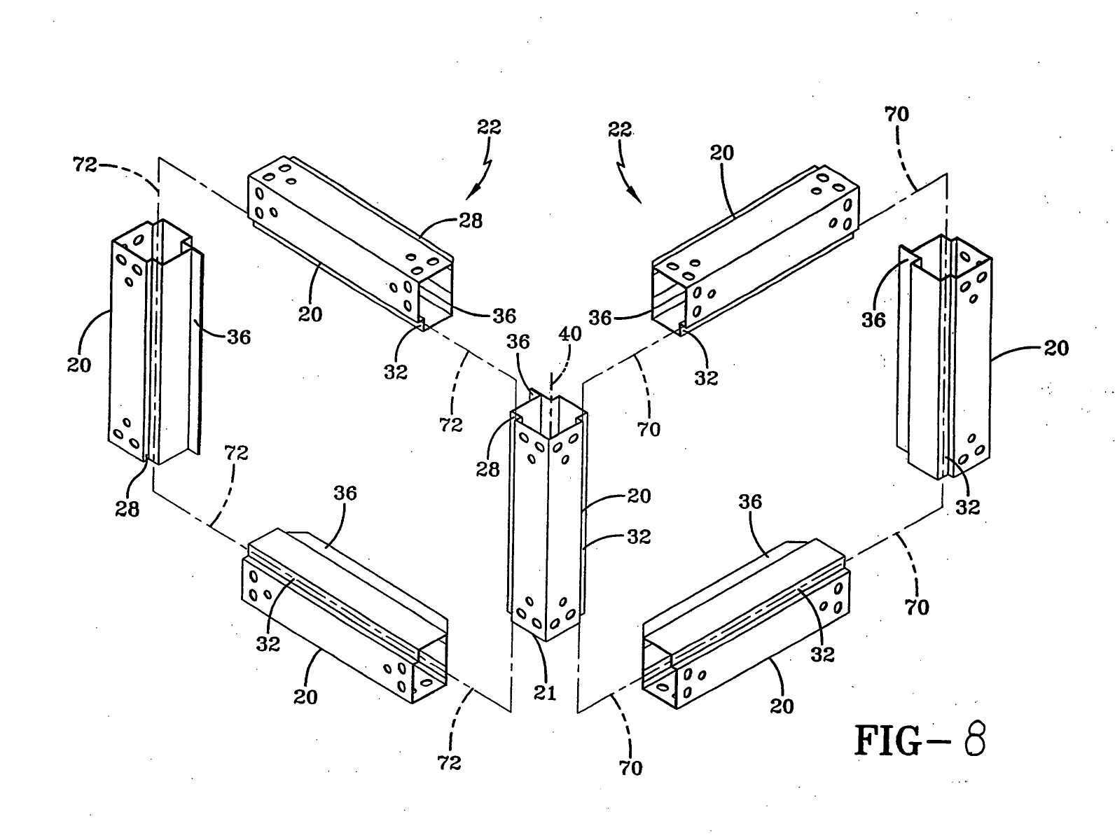

A second insulating material 324, such as polyurethane foam, is injected by an injection gun (not shown) inside the chamber 320 through apertures (not shown) formed in the fixture 302 using a specially configured press to ensure the fixture 302 and the exterior skin 316 are sufficiently supported against the force of the insulating material 322 that is injected at an elevated pressure level. The volume of the chamber 320, minus the volumes of the first insulating material 322, perforated sheet 326 and film sheet 328, is calculated prior to the injection operation. In a preferred embodiment, as shown in FIG. 7, the amount of the first insulating material 322 occupies about one-half of the volume that defines the chamber 320, although different proportions of the first insulating material 322 can be used, for example, about one-third to about two-thirds. An additional volume of second insulating material 324 is accounted for as there is an amount of compression of the first insulating material 322 during the injection process. However, despite the amount of compression, which can exceed about ten percent of the undeformed volume of second insulating material 328, the sound attenuating capability of the second insulating material 324 is not significantly reduced. That is, the sound attenuation capability of an embodiment of panel 300 as shown in FIG. 7 is comparable to an embodiment of a panel that is fully filled with fiberglass material. During the injection process, a precise amount of insulating material 322 is injected into the chamber 320 by correcting for the ambient conditions at the time of injection as it is desirable to completely fill the remaining portion of the chamber 320 with the second insulating material 328. Since the flow rate of the injected second insulating material 324 through the injection gun is a known value, the duration of flow is the variable parameter, which is precisely controlled to achieve the proper amount of injected second insulation material 324. To provide a favorable bonding interface between the exposed inner surfaces of the chamber 320 and the expanding, injected second insulating material 328, the press platens that secure the exterior skin 316 and the fixture 302 may be heated, preferably up to about 100° F. for polyurethane foam material. Once the injection process is completed and the second injected insulation material 324 has cured, the insulated panel 300 is installed in the AHU frame structure.

The insulated panels 300 provide improved acoustic attenuation performance in another way. The insulated panels 300 containing a solid layer of insulating material substantially filling the chamber 320 may have a significant coincidence effect, which occurs at its critical frequency. Coincidence is defined as a significant reduction in sound transmission loss (i.e., a significant increase in the transmission of sound) through a partition that occurs at critical frequency. The critical frequency is the frequency at which the wavelength of sound in air equals the flexural bending wavelength in the partition or material. Stated another way, coincidence occurs when the wavelength of sound in air, projected on the plane of the panel 300, matches the bending wavelength of the panel 300. Coincidence is typically limited to flat panels. At coincidence, the panel 300 may be substantially transparent to sound at certain frequencies, such as about 1,000 Hz although panel thickness, aspect ratio and other factors may significantly change this frequency. Internal damping, if any, may help control the insertion loss. Without dampening which occurs due to the first insulating material 322, the second insulating material 328 is otherwise tightly bonded to all of the inner surfaces of the fixture 302 and the exterior skin 316, the insulated panel 300 acting as a homogenous plate. That is, the first insulating material 322 bonds the fixture 302 and the exterior skin 316 tightly together so that they move as one plate.

The first insulating material layer 322 provides some dampening of the coincidence reduction at about 1,000 Hz, or other frequencies at which coincidence reduction occurs. Since the first insulating material 322 occupies a fractional volume of the chamber 320, including abutting a portion of the inner surfaces of the chamber 320, the amount of inner surface available to bond with the second insulating material 324 is reduced. Due to this reduced amount of inner surface area with which to bond to the second insulating material 324, it is believed that the insulated panel 300 will no longer move as one plate. By no longer moving as one plate, coincidence of the panel 300 is reduced, thereby improving acoustic performance.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A panel for use in an air handling unit comprising:
a skin;
a fixture, the fixture having:
a base disposed opposite the skin;
an opening formed in the base; and
at least one riser extending substantially perpendicular from the base, the at least one riser being secured to the skin to form an enclosed chamber between the skin and the fixture; and
a perforated sheet disposed over the opening;
a layer of film disposed on a surface of the perforated sheet facing the skin;
a first insulating material disposed on a surface of the film layer opposite the perforated sheet; and
a second insulating material disposed in the enclosed chamber between the first insulating material and the skin.

2. The panel of claim 1 wherein the perforated sheet is disposed inside the fixture.

3. The panel of claim 1 wherein the perforated sheet is disposed exterior of the fixture.

4. The panel of claim 1 wherein the first insulating material occupies from about one-third to about two-thirds of the chamber.

5. The panel of claim 1 wherein the first insulating material occupies about one-half of the chamber.

6. The panel of claim 1 wherein the second insulating material is a foam.

7. The panel of claim 6 wherein the foam is a polyurethane foam.

8. The panel of claim 7 wherein the polyurethane foam is injected into the panel.

9. The panel of claim 8 wherein the injected polyurethane foam compresses the first insulating material up to about 10 percent.

10. The panel of claim 9 wherein the injected polyurethane foam bonds to surfaces of the skin and fixture.

11. An air handling unit framework comprising:
a skin;
a fixture, the fixture having:
a base disposed opposite the skin;
an opening formed in the base; and
at least one riser extending substantially perpendicular from the base, the at least one riser being secured to the skin to form an enclosed chamber between the skin and the fixture; and
a perforated sheet disposed over the opening;
a layer of film disposed on a surface of the perforated sheet facing the skin;
a first insulating material disposed on a surface of the film layer opposite the perforated sheet;
a second insulating material disposed in the enclosed chamber between the first insulating material and the skin;
a plurality of interconnected structural members forming a plurality of interconnected frames, each frame of the plurality of frames receiving a panel; and
wherein the plurality of interconnected frames and corresponding panels are configured and disposed to form an air handling unit framework.

12. The panel of claim 11 wherein the perforated sheet is disposed inside the fixture.

13. The panel of claim 111 wherein the perforated sheet is disposed exterior of the fixture.

14. The panel of claim 11 wherein the first insulating material occupies from about one-third to about two-thirds of the chamber.

15. The panel of claim 11 wherein the second insulating material is a foam.

16. A method of assembling a panel for use in an air handling unit, comprising the steps of:
providing a skin;
providing a fixture, the fixture having:
a base disposed opposite the skin;
an opening formed in the base; and
at least one riser extending from the base; and
bending the at least one riser substantially perpendicular from the base;
disposing a perforated sheet over the opening;
disposing a layer of film on a surface of the perforated sheet facing the skin;
disposing a first insulating material on a surface of the film layer opposite the perforated sheet;
securing the at least one riser to the skin to form an enclosed chamber between the skin and the fixture; and
disposing a second insulating material in the enclosed chamber between the first insulating material and the skin.

17. The method of claim 17 wherein the step of disposing a perforated sheet over the opening includes the step of disposing a perforated sheet inside the fixture over the opening.

18. The method of claim 17 wherein the step of disposing a perforated sheet over the opening includes the step of disposing a perforated sheet exterior of the fixture over the opening.

19. The method of claim 17 wherein the step of disposing a second insulating material in the enclosed chamber is achieved by injection.

20. The method of claim 17 wherein the first insulating material occupies from about one-third to about two-thirds of the chamber.
